(19) United States
(12) Patent Application Publication
(10) Pub. No.: US 2018/0120879 A1
(43) Pub. Date: May 3, 2018

(54) VOLTAGE REGULATOR WITH ENHANCED POWER SUPPLY REJECTION RATIO AND LOAD-TRANSIENT PERFORMANCE

(71) Applicant: QUALCOMM Incorporated, San Diego, CA (US)

(72) Inventors: Mengmeng DU, San Diego, CA (US); Hua GUAN, San Diego, CA (US)

(21) Appl. No.: 15/438,605

(22) Filed: Feb. 21, 2017

Related U.S. Application Data
(60) Provisional application No. 62/413,890, filed on Oct. 27, 2016.

(51) Int. Cl. G05F 1/575

(52) U.S. Cl. CPC G05F 1/575

(57) ABSTRACT

A voltage regulation circuit improves power supply rejection ratio and load-transient performance. The voltage regulation circuit includes a low dropout (LDO) voltage regulator and an inverting amplifier stage. The LDO voltage regulator includes a first error amplifier and a power field effect transistor (FET). The first error amplifier includes a first input and a second input. The second input receives an output signal fed back from the LDO voltage regulator. The inverting amplifier stage includes an output terminal coupled to the first input of the first error amplifier. The inverting amplifier stage also includes a first input that receives the output fed back from the LDO voltage regulator and a second input that receives a reference voltage.

### CROSS-REFERENCE TO RELATED APPLICATION

The present application claims the benefit of U.S. Provisional Patent Application No. 62/413,890, filed on Oct. 27, 2016, and titled “ENHANCED POWER SUPPLY REJECTION RATIO AND LOAD-TRANSIENT PERFORMANCE,” the disclosure of which is expressly incorporated by reference herein in its entirety.

### TECHNICAL FIELD

The present disclosure generally relates to power management systems. More specifically, aspects of the present disclosure relate to power supply rejection ratio (PSRR) and load-transient performance of a low dropout (LDO) voltage regulator.

### BACKGROUND

A wireless device (e.g., a cellular phone or a smartphone) in a wireless communication system may transmit and receive data for two-way communication. The wireless device may include a transmitter for data transmission and a receiver for data reception. For data transmission, the transmitter may modulate a radio frequency (RF) carrier signal with data to obtain a modulated RF signal, amplify the modulated RF signal to obtain an amplified RF signal having the proper output power level, and transmit the amplified RF signal via an antenna to a base station. For data reception, the receiver may obtain a received RF signal via the antenna and may amplify and process the received RF signal to recover data sent by the base station.

Many modern electronic systems (e.g., wireless device) rely on one or more batteries for power. The batteries are typically recharged, for example, by connecting the electronic system to a power source (e.g., an alternating current (AC) power outlet) via a power adapter and cable.

A regulator or voltage regulator may provide a power supply rail from a battery. The voltage regulator increasingly has to service multiple subsystems (e.g., loads) in electronic devices. These subsystems may have different power supply voltage specifications and load current specifications. The power delivery capability of the voltage regulator, however, is limited by the power available from the battery. Under certain conditions, the voltage regulator may not be able to provide sufficient power to meet all the demands of all the device subsystems. When load currents of multiple ones of the device subsystems increase, the power supply voltage at the output of the voltage regulator (Vout) may droop, causing one or more of the device subsystems to fail.

A linear voltage regulator generally produces a regulated direct current (DC) output voltage rail (V_{OUT}) from an input supply voltage rail (V_{IN}), in which unwanted, excess voltage is dropped across the linear voltage regulator. This excess voltage (=V_{IN}−V_{OUT}) is commonly referred to as the “headroom” of the linear voltage regulator. In operation, linear voltage regulators generally operate in a step-down mode, in which the output voltage V_{OUT} is stepped down from the input voltage (e.g., V_{OUT}<V_{IN}). The term “dropout” may refer to the minimum headroom value supported by a linear voltage regulator.

A low dropout (LDO) regulator is one type of linear voltage regulator that is popular in battery powered devices, in which the input voltage V_{IN} dips to a level approximately equal, but still greater than the output voltage. An LDO regulator (or LDO voltage regulator) is designed to provide a stable regulated output voltage rail in situations where the dropout of the voltage regulator is less than or equal to a predetermined minimum value. For example, a low dropout voltage regulator supports stable output voltage rail regulation when the difference between the input voltage V_{IN} and a regulated output voltage V_{OUT} is larger than or equal to the predetermined minimum value (e.g., 0.2 volts). However, some conventional LDO voltage regulators are subject to degraded performance by producing a poor power supply rejection ratio (PSRR), transient response, or the like.

### SUMMARY

In an aspect of the present disclosure, a voltage regulation circuit includes a low dropout (LDO) voltage regulator including a first error amplifier and a power field effect transistor (FET). The first error amplifier includes a first input and a second input. The second input receives an output signal fed back from the LDO voltage regulator. The voltage regulation circuit also includes an inverting amplifier stage having an output terminal coupled to the first input of the first error amplifier. The inverting amplifier stage has a first input that receives the output fed back from the LDO voltage regulator and a second input that receives a reference voltage.

In an aspect of the present disclosure, a voltage regulation circuit includes a low dropout (LDO) voltage regulator including a first error amplifier and a power field effect transistor (FET). The first error amplifier includes a first input and a second input. The second input receives an output signal fed back from the LDO voltage regulator. The voltage regulation circuit also includes means for amplifying a voltage. The voltage amplifying means is coupled to the first input of the first error amplifier. The voltage amplifying means includes means for receiving the output fed back from the LDO voltage regulator and means for receiving a reference voltage.

In yet another aspect of the present disclosure, a voltage regulation method in a voltage regulation device includes transmitting a reference voltage from an inverting amplifier stage to a first input of a first error amplifier of an LDO voltage regulator (low dropout voltage regulator) when the voltage regulation device is operating in accordance with a direct current. The method also includes transmitting a different voltage from the inverting amplifier stage to the first input of the first error amplifier of the LDO voltage regulator when the voltage regulation device is operating in accordance with an alternating current.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 depicts a simplified system for delivering power in an electronic device according to one aspect of the present disclosure.

FIG. 2 depicts a more detailed example of the system according to one aspect of the present disclosure.

FIG. 3 illustrates a voltage regulating device including a low dropout (LDO) voltage regulator.

FIG. 4A illustrates a voltage regulating device including a low dropout (LDO) voltage regulator and an auxiliary inverting amplifier stage according to aspects of the present disclosure.

FIG. 4B illustrates a loop gain measurement implementation of a voltage feedback loop including the auxiliary inverting amplifier stage according to aspects of the present disclosure.

FIG. 4C illustrates a small-signal equivalent circuit model of a power amplifier/transistor of the voltage feedback loop including the auxiliary inverting amplifier stage according to aspects of the present disclosure.

FIG. 5 depicts a simplified flowchart of a voltage regulating method according to one aspect of the present disclosure.

FIG. 6 is a block diagram showing an exemplary wireless communication system in which an aspect of the present disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR” and the use of the term “or” is intended to represent an “exclusive OR”.

Power supply rejection ratio (PSRR) and load-transient performance of a low dropout (LDO) voltage regulator highly depends on loop gain and bandwidth of the LDO voltage regulator. PSRR describes an amount of noise from a power supply that a particular device can reject. One way to improve the loop gain is to increase an output resistance, Rout, of an error amplifier of the LDO voltage regulator. However, improving the loop gain by increasing Rout of the error amplifier decreases its bandwidth, which degrades the PSRR at a high frequency. One way to improve bandwidth is by increasing transconductance, Gm, of the error amplifier. Improving bandwidth by increasing the transconductance, Gm, of the error amplifier, however, decreases loop gain, which in turn degrades PSRR at low frequency, and consumes large quiescent current of up to tens of micro amperes.

Aspects of the present disclosure are directed to a circuit architecture and technique for improving power supply rejection ratio (PSRR) from the LDO voltage regulator across an entire frequency of interest while improving the loop gain and bandwidth of the LDO voltage regulator. In some implementations, the PSRR may be improved as much as 10 dB across the entire frequency of interest. The improved PSRR, loop gain and bandwidth of the LDO voltage regulator is achieved by using an auxiliary inverting amplifier stage coupled to or integrated into the LDO voltage regulator.

In one aspect of the disclosure, the auxiliary inverting amplifier stage is a low quiescent current auxiliary inverting amplifier stage, which is coupled to an input portion of a main error amplifier of the LDO voltage regulator. Thus, the main error amplifier receives an input from the low quiescent current auxiliary inverting amplifier stage. For example, the auxiliary inverting amplifier stage consumes quiescent current of less than 3 uA, and can be implemented with a simple structure that covers a small area of about two thousand micrometer squared (2000 μm²), which is less than about three percent of the controller area. The LDO voltage regulator includes the power transistor and the controller, which generally includes the error amplifier and a buffer, among others.

In one aspect of the disclosure, a voltage regulation circuit or device includes a low dropout (LDO) voltage regulator and an auxiliary inverting amplifier stage. The inverting amplifier stage may include another error amplifier. The power transistor may be a field effect transistor (FET). The error amplifier of the LDO voltage regulator may include multiple inputs (e.g., two inputs). One of the inputs of the error amplifier of the LDO voltage regulator receives an output that is fed back from an output terminal of the LDO voltage regulator. The other input of the error amplifier of the LDO voltage regulator is coupled to an output of the inverting amplifier stage. The inverting amplifier may also include multiple inputs (e.g., two inputs). One input of the inverting amplifier stage receives the output that is fed back from the output terminal of the LDO voltage regulator. The other input of the inverting amplifier stage receives a reference voltage.

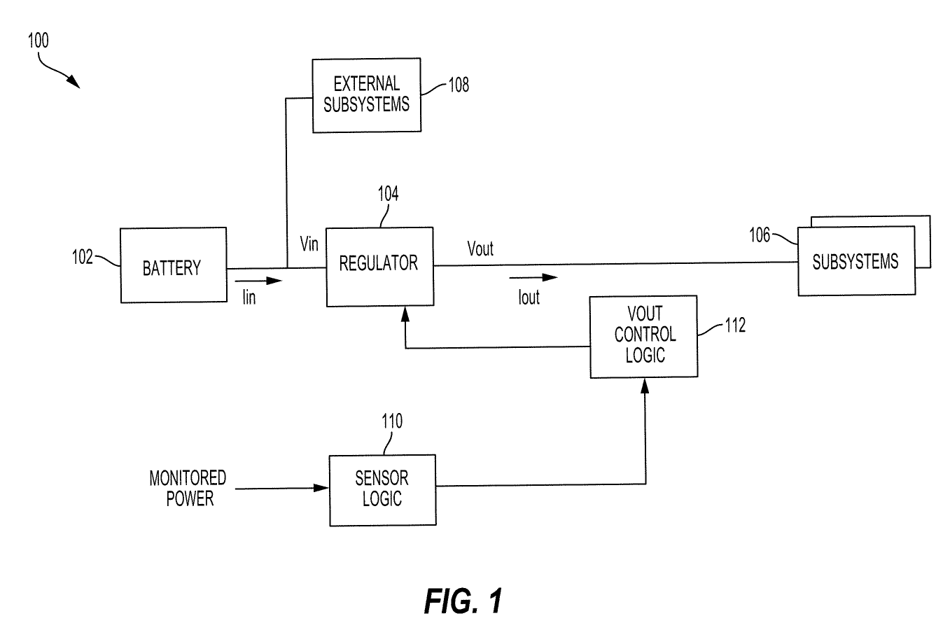

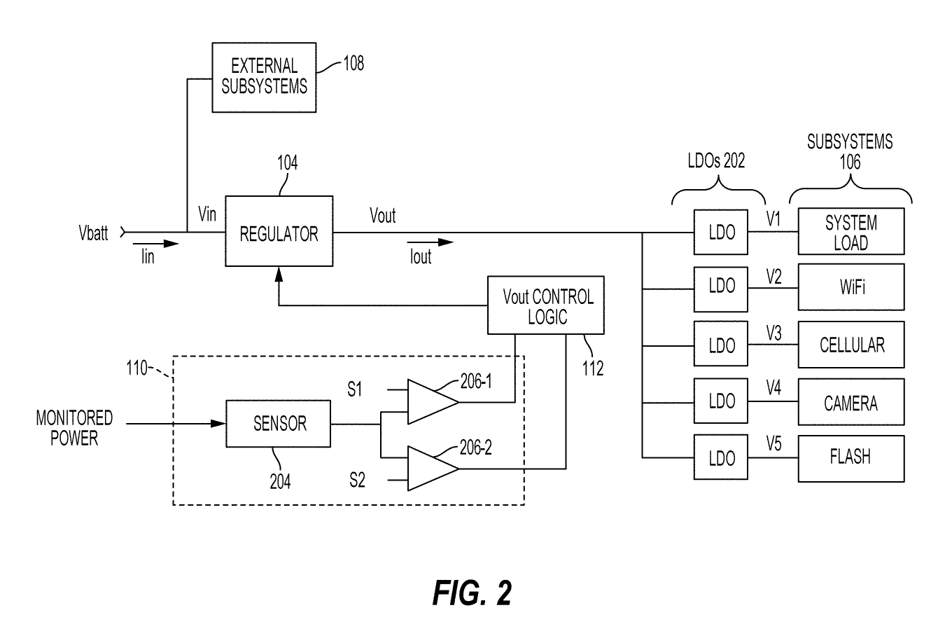

Aspects of the present disclosure achieve enhanced or improved PSRR and load-transient performance of the LDO voltage regulator with minimum or reduced quiescent current consumption. The PSRR and load-transient performance are improved across all process, temperature, voltage and load current to which the LDO voltage regulator is subjected. The aspects of the present disclosure may be implemented in a system, such as the system illustrated in FIGS. 1 and 2.

FIG. 1 depicts a system 100 for delivering power in an electronic device according to one aspect of the present disclosure. The system 100 includes a battery 102 that may provide a power supply voltage from outside a chip including a voltage regulator (e.g., regulator 104). The regulator 104 may deliver a power supply voltage (e.g., a voltage rail) from the battery 102 to different subsystems 106. Additionally, external subsystems 108 may be located external to the chip that includes the regulator 104. The external subsystems 108 may not draw power from the regulator 104, but may still draw power from the battery 102.

The system 100 may be part of an electronic device, such as a cellular phone, tablet, or other mobile device. In one aspect, the regulator 104 is highly integrated in the electronic device with the subsystems 106 and the external subsystems 108. The regulator 104 may be a buck regulator, a boost regulator, and/or a buck-boost regulator. The regulator 104 regulates the output voltage Vout from the regulator 104 to different subsystems 106. For example, in boost mode, the regulator 104 may increase the level of an input voltage Vin that is received from the battery 102. Additionally, in buck mode, the regulator 104 may decrease the level of the input voltage Vin that is received from the battery 102.

The system 100 includes subsystems 106 (e.g., loads) that draw power from the regulator 104. These subsystems 106 may include different minimum power supply voltage specifications. For example, the minimum operating voltage may be a level below which the subsystems may no longer operate properly. The subsystems 106 may draw different levels of power (e.g., current and/or voltage) at different times depending on the operations the subsystems are performing. Further, different subsystems may draw power at different times, such as a subsystem may draw power when actively performing an operation, but not draw a lot of power when idle. For example, an electric flash on a camera may draw a large current for a short time when the flash is operated, a WiFi or cellular subsystem may draw a large current during transmission, or a computer processor may draw a large current while processing a large instruction block.

In a highly-integrated system, such as a mobile phone or tablet computer, the power delivery capability of the regulator 104 is limited by the power available from the battery 102. Under certain conditions, the regulator 104 may not be able to provide sufficient power to meet all the demands of the subsystems 106. When the power specified for multiple subsystems increases past the available power, the power supply voltage at the output of the regulator 104 may droop, causing one or more subsystems 106 to fail.

Sensor logic 110 and Vout control logic 112 may be provided to adjust the output voltage Vout such that the regulator 104 is able to provide sufficient power to the subsystems 106. In one aspect, sensor logic 110 and Vout control logic 112 may be part of the regulator 104. The sensor logic 110 monitors power in the electronic device and uses multiple thresholds to determine when to increase or decrease the output voltage Vout of the regulator 104. The thresholds may be set below an absolute limit threshold in which the electronic device may not operate properly if the absolute limit is met. Vout control logic 112 controls the output voltage Vout by increasing or decreasing the output voltage in increments. The output voltage Vout may only be decreased to the minimum voltage level or increased to a maximum voltage level. These levels are based on voltage levels requested from a set of subsystems and priority levels associated with those subsystems.

FIG. 2 depicts a more detailed example of the system 100 of FIG. 1. In this example, an implementation of sensor logic 110 is shown, but it will be recognized that other implementations are possible. For example, the sensor logic 110 may be implemented in analog circuits, digital circuits, and/or software.

The regulator 104 receives a battery voltage Vbatt (or current Iin) from the battery 102, and provides an output voltage Vout (or current Tout) to low drop-out (LDO) regulators 202 that customize the internal power supply voltage to each of the subsystems 106. For example, a system load may specify a voltage V1, a WiFi subsystem may specify a voltage V2, a cellular subsystem may specify a voltage V3, a camera subsystem may specify a voltage V4, and a flash subsystem may specify a voltage V5. These voltages may be the minimum voltage specified for the subsystems to operate properly. For example, if the output voltage drops below this level, a subsystem may experience decreased performance. However, in some cases, the subsystem may not experience a total failure.

Each of these subsystems 106 may be assigned a priority from multiple different priorities. For example, a first higher priority is defined as a “priority level 1” and a second lower priority is defined as a “priority level 0”. The minimum and maximum output voltage Vout levels of the regulator 104 are generated based on the priorities and the power supply voltages being requested by subsystems 106. For example, a minimum allowable Vout level is defined by the requested power supply voltages of subsystems 106 that are designated as “priority level 1.”

In one example, the WiFi subsystem may specify 3.6 V to operate properly, but others of the subsystems 106, such as the system load, may specify only 3.3 V. WiFi may be designated as a low priority load and assigned the priority level 0 and the system load is designated as a high priority level 1. In this case, during high power loading, it may be acceptable to reduce the power supply output voltage Vout to be lower than 3.6 V (the level requested by WiFi), but not less than 3.3 V (the level requested by the system load). This reduced voltage may reduce the performance of the WiFi subsystem, but the user impact might be minimal. In this case, as long as the power supply voltage is above 3.3 V, the priority level 1 subsystems 106 may operate properly, but the WiFi subsystem may possibly operate with a reduced performance. WiFi is considered a lower priority and the reduced performance is tolerated and may not noticeably impact a user of the electronic device. At the expense of reduced performance of the WiFi subsystem, a shutdown of any subsystem or the entire electronic device may be avoided.

Sensor logic 110 includes a sensor 204 that monitors the power from one or more locations in the electronic device. The locations may be at the input of the regulator 104, the output of the regulator 104, within the regulator 104, the output of the battery 102, and the input of external subsystems 108. In one aspect, the sensor 204 monitors the input current through the regulator 104, such as through an inductor of the regulator 104. In other examples, either the current or the voltage output by the battery 102 or input to external subsystems 108 may be monitored.

Comparison logic shown as a first comparator 206-1 and a second comparator 206-2 receives the monitored power and can compare the monitored power to different thresholds. For example, the first comparator 206-1 compares the power to a first threshold S1 and the second comparator 206-2 compares the power to a second threshold S2. The first threshold S1 and the second threshold S2 may be early warning levels that control the automatic adjustment of the output voltage of the regulator 104. A third absolute threshold Lim may be an absolute threshold. The system may stop operating properly if the power goes above this limit. In this case, the electronic device or a subsystem may shut down or other undesirable measures taken. In one example, the thresholds may be current thresholds if current is being monitored, such as the first threshold S1 is 3.5 A, the second threshold S2 is 3 A, and the absolute threshold Lim may be 4 A. Other thresholds may also be used, such as power or voltage thresholds. That is, the absolute threshold Lim is above the threshold S1, which is above the threshold S2. By providing the other thresholds S1 and S2, the Vout control logic 112 may adjust the output voltage Vout of the regulator 104 such that the threshold Lim may not be reached. This may avoid an undesirable shutdown of components of the electronic device.

When the monitored power meets the first threshold S1 (is equal to and/or above), the first comparator 206-1 outputs a signal, such as a “high” signal to the Vout control logic 112. Additionally, when the monitored power meets the second threshold S2 (e.g., is equal to or below), the second comparator 206-2 outputs a high signal to the Vout control logic 112. Conversely, when the power goes below the first threshold or above the second threshold, the comparators 206-1 and 206-2, respectively, output a “low” signal to Vout control logic 112.

When threshold S1 is met, the Vout control logic 112 may send a signal to the regulator 104 to step the output voltage Vout down an increment. The increment may be preset and may be around 32 millivolt (mV)/6 microseconds (μs). When the threshold S2 is met, then Vout control logic 112 may output a signal to the regulator 104 to increase the output voltage by an increment, such as by the same 32 mV/6 μs increment. Each time one of the thresholds is met, the Vout control logic 112 may signal the regulator 104 to adjust the output voltage by another increment. In one aspect, once the threshold is hit and goes above or below the threshold, the signal should be cleared before it can be met again. In other aspects, at every clock cycle, the power is checked, and if one of the thresholds is met, the signal is asserted again.

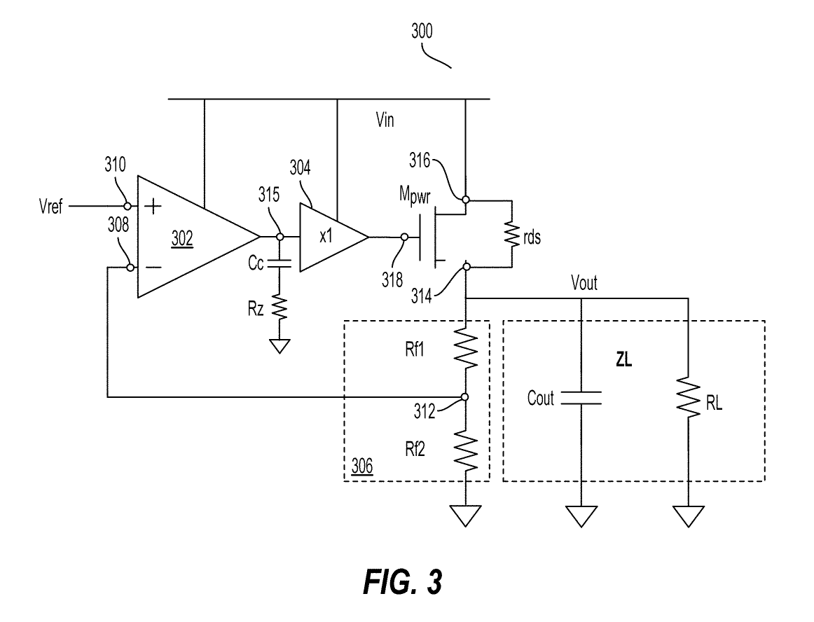

FIG. 3 illustrates a voltage regulating device including a low dropout (LDO) voltage regulator 300. The LDO voltage regulator 300 includes a first error amplifier 302, a first buffer driver 304, and a power transistor M_{pwr}. The LDO voltage regulator 300 receives an input voltage Vin and generates a regulated output voltage Vout using the power transistor M_{pwr} (e.g., an NMOS transistor) as the power device. For example, a drain terminal 316 of the power transistor M_{pwr} receives the input voltage Vin while a source terminal 314 of the power transistor M_{pwr} provides the output voltage Vout. The output voltage Vout drives a load. The load may be represented by a resistor RL. An output filter Cout may be coupled to the source terminal 314 of the power transistor M_{pwr}. The capacitor Cout may be used to achieve acceptable overshoot/undershoot of the LDO voltage regulator's load transient response. For example, Cout may be implemented as a filter to filter the voltage at the output of the power transistor M_{pwr}. The impedance of a combination of the resistor RL and the output filter Cout is represented by ZL.

A gate terminal 318 of the power transistor M_{pwr} receives a gate drive signal generated by a feedback control loop to modulate a gate voltage of the power transistor M_{pwr} for regulating the output voltage Vout. The feedback control loop may include the first error amplifier 302, the first buffer driver 304, the power transistor M_{pwr} and feedback resistors Rf1 and Rf2. For example, the gate drive signal may be received via the first error amplifier 302 and the first buffer driver 304. The control loop generates the gate drive signal for modulating the gate voltage of the power transistor M_{pwr} based on the output voltage Vout. Similar to the power transistor M_{pwr}, the first error amplifier 302 and the first buffer driver 304 are powered by the input voltage Vin.

The control loop may also include a capacitor Cc and a resistor Rz coupled to a terminal 315 between the first error amplifier 302 and the first buffer driver 304. The capacitor Cc and the resistor Rz may be arranged in a series configuration. The capacitor Cc is a compensation capacitor of the feedback control loop. The capacitor Cc creates a dominant pole of the feedback control loop with an output resistance of the first error amplifier 302. The resistor Rz in conjunction with the capacitor Cc creates zero of the feedback control loop to cancel the non-dominant pole created by the capacitor Cout and the resistor RL. The capacitor Cc and the resistor Rz are used to stabilize the feedback control loop.

In operation, the feedback control loop regulates the feedback voltage Vfb to a reference voltage Vref. The voltage division may be implemented using the resistors Rf1 and Rf2, such that the output voltage Vout equals Vref(1+Rf1/Rf2). For example, the first error amplifier 302 in the feedback control loop receives the output voltage, or a voltage indicative of the output voltage, on its negative input terminal 308 and the first reference voltage Vref on its positive input terminal 310. The first error amplifier 302 may receive the voltage indicative of the output voltage Vout through the voltage divider 306. For example, a terminal 312, between the resistors Rf1 and Rf2, is coupled to the negative input terminal 308 of the first error amplifier 302 to provide the voltage (e.g., Vfb) indicative of the output voltage Vout to the first error amplifier 302. In one configuration, low frequency ranges from direct current (DC) to approximately 100 Hz.

The voltage divider 306 may be implemented as a current-voltage converting circuit. For example, a current is generated at the source terminal 314 of the power transistor M_{pwr}. A portion of the current is sent to the voltage divider 306 or current-voltage converting circuit to be converted to an output voltage Vout to drive a load. The output voltage Vout may be divided to a feedback voltage Vfb, which is indicative of the output voltage Vout, to be transmitted to the first error amplifier 302. The feedback voltage Vfb is compared with the reference voltage Vref. The first error amplifier 302 generates an output signal indicative of the difference between the output voltage Vout or the voltage indicative of the output voltage Vout, and the reference voltage Vref. The output signal of the first error amplifier is buffered by the first buffer driver 304 to generate the gate drive signal. The output of the first error amplifier 302 controls the voltage level of the gate of the power transistor M_{pwr} to maintain the value of the output voltage Vout.

According to the implementation of FIG. 3, the power supply rejection ratio (PSRR) at a high frequency may be improved by boosting the transconductance, Gm, of the first error amplifier 302, which decreases loop gain and in turn degrades PSRR at low frequency. Further, boosting the transconductance, Gm, of the error amplifier 302 consumes large quiescent current of up to tens of micro amperes (e.g., an addition 35 μA). Additionally, boosting the transconductance, Gm, of the error amplifier consumes a large area (with a corresponding increase in cost) of the power management integrated circuit in which the LDO voltage regulator is implemented. For example, the increased area consumption may be due to an implementation of extra current biasing branches.

Other implementations fall short of improving PSRR from the LDO voltage regulator across an entire frequency of interest while improving the loop gain and bandwidth of the LDO voltage regulator. For example, a loop input voltage Vᵢₙ_{_}ₗₒₒₚ may be injected into a control loop of the LDO voltage regulator to cancel coupled Vin noise. The loop input voltage Vᵢₙ_{_}ₗₒₒₚ may be provided to a gate of a power transistor. This approach, however, only works at a certain load point and a certain headroom of the power transistor while PSRR is degraded over a range of loads with different headroom.

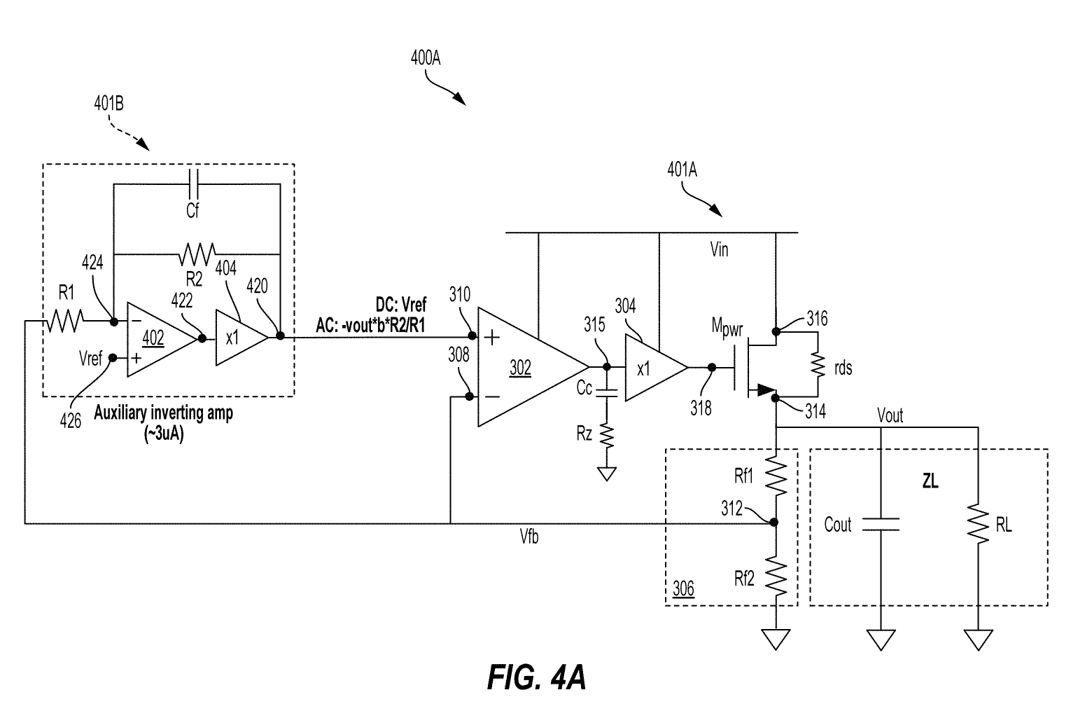

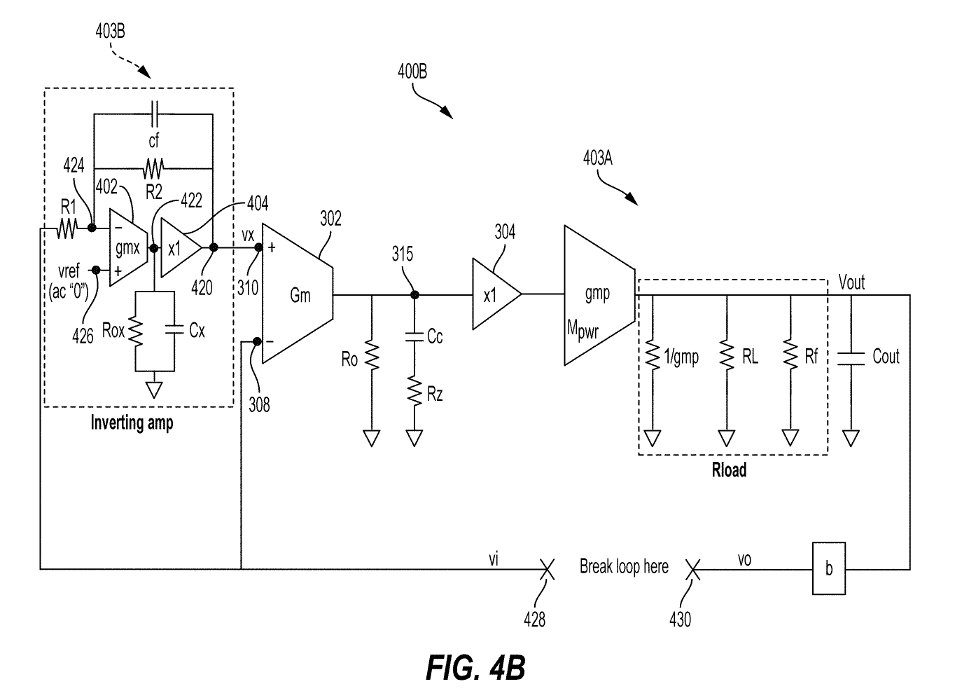

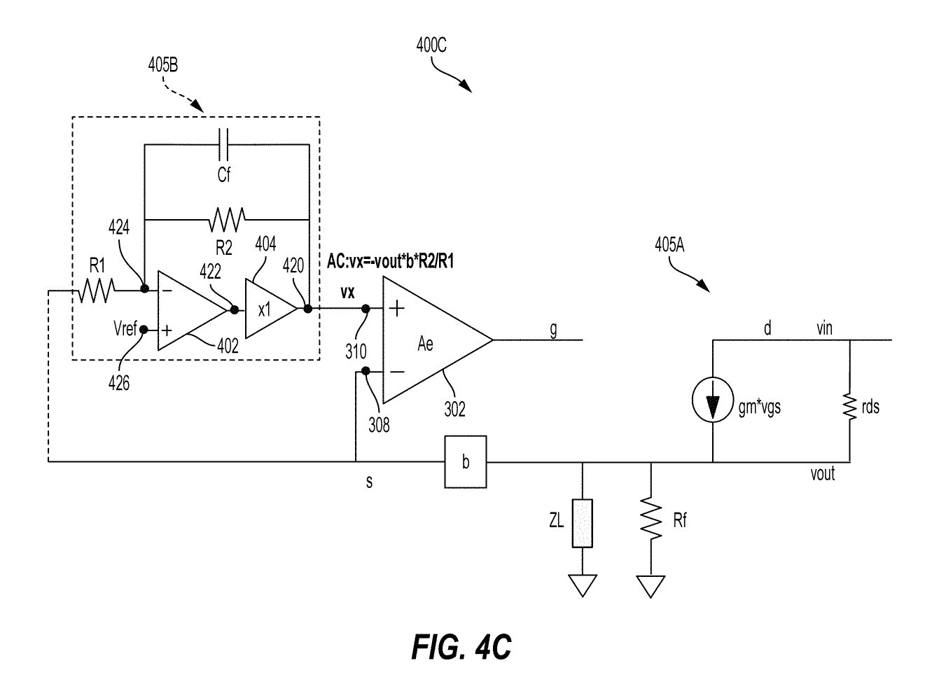

Other implementations use an auxiliary LDO voltage regulator that is exactly the same as a main LDO voltage regulator of a voltage regulation device to generate a replica of an output voltage Vout of the main LDO voltage regulator. In this implementation, the output voltage from the auxiliary LDO voltage regulator is subject to a same input voltage coupled noise over a frequency band as the main LDO voltage regulator output voltage. Accordingly, the output voltage of the auxiliary LDO voltage regulator cancels the input voltage coupled noise at the output voltage of the LDO voltage regulator to achieve an improved PSRR. However, this implementation is very expensive and is subject to challenges associated with making the loads of the two LDO voltage regulators exactly equal. To mitigate these shortcomings, aspects of the present disclosure are directed to improving PSRR by employing an auxiliary inverting amplifier, as illustrated in FIGS. 4A, 4B and 4C.

FIG. 4A illustrates a voltage regulating device 400A including a low dropout (LDO) voltage regulator 401A and an auxiliary inverting amplifier stage 401B according to aspects of the present disclosure. For illustrative purposes, some of the labelling and numbering of the components and features of FIG. 4A are similar to those of FIG. 3. The difference between the voltage regulating device 400A and the LDO voltage regulator 300 is that the voltage regulating device 400A includes the auxiliary inverting amplifier stage 401B. The auxiliary inverting amplifier stage 401B includes a second error amplifier 402, a second buffer driver 404, a capacitor Cf, and first and second resistors R1 and R2. The first resistor R1 is in series with the second error amplifier 402 and/or the second buffer driver 404, and the second resistor R2 is in parallel with the second error amplifier 402 and/or the second buffer driver 404. The resistors R1 and R2 control the gain of the auxiliary inverting amplifier at low frequency. The capacitor Cf is in parallel with the second error amplifier 402, the second resistor R2 and/or the second buffer driver 404.

Similar to the LDO voltage regulator 300, the LDO voltage regulator 401A includes the first error amplifier 302 and the power transistor M_{pwr}. The negative input terminal 308 of the first error amplifier 302 of the LDO voltage regulator 401A receives an output signal, Vfb, which is fed back from an output terminal (e.g., source terminal 314) of the LDO voltage regulator 401A. Unlike the LDO voltage regulator 300 of FIG. 3, the positive input terminal 310 of the first error amplifier 302 of the LDO voltage regulator 401A is coupled to an output terminal 420 of the auxiliary inverting amplifier stage 401B. For example, the output terminal 420 corresponds to an output terminal of a second buffer driver 404. An output terminal 422 of the second error amplifier 402 is coupled to an input terminal of the second buffer driver stage. The second error amplifier 402 includes a positive input terminal 426 and a negative input terminal 424. The negative input terminal 424 of the second error amplifier 402 receives the output Vfb that is fed back from the output terminal of the LDO voltage regulator 401A via the resistor R1. The positive input terminal 426 of the second error amplifier 402 receives a reference voltage Vref.

When the auxiliary inverting amplifier stage 401B is added at the positive input terminal 310 of the main or first error amplifier 302, from a direct current (DC) perspective, the input voltage at the positive input terminal 310 of the first error amplifier 302 is still the voltage reference Vref. For example, the reference voltage may be 0.3215 V. However, from an alternating current (AC) perspective, the input voltage at the positive input terminal 310 of the first error amplifier 302 is a function of the feedback voltage Vfb (or Vout*b, where b is a voltage divider ratio) and the first and second resistors R1 and R2. For example, with respect to the alternating current scenario, the input voltage at the positive input terminal 310 is given as follows:

Vinₜₑᵣₘᵢₙₐₗ₃₁₀=−b*Vout*R2/R1.

Equivalently, a “differential AC signal” (rather than single-ended AC signal) may be applied to the first error amplifier 302. Thus, higher loop gain, bandwidth and better PSRR are achieved. This aspect of the present disclosure, which incorporates the auxiliary inverting amplifier stage 401B, consumes much smaller quiescent current than conventional implementations (e.g., existing turbo mode implementations). Using an N-emitter SiGe P-base Schottky metal-collector (NPM) as a baseline, this aspect consumes an additional current of about 3 μA while the existing turbo mode consumes an addition current of about 35 μA.

The inverting amplifier can be a simple cascade operational transconductance amplifier (OTA)) following a source follower transistor. The inverting amplifier may also be a non-cascade amplifier, a driver amplifier or any other type of amplifier. The first and the second resistors R1 and R2 can be implemented by Rds of the power transistor (e.g., metal-oxide-semiconductor field-effect transistor (MOSFET)). Rds is the channel resistance of the power transistor. The capacitor Cf may be a metal-insulator-metal (MIM) capacitor and may have a capacitance of about 50 femtofarads (fF). The capacitor Cf creates a zero with the resistors R1 and R2 and is used to further stabilize the control loop of the LDO voltage regulator. Although a specific layout of capacitors and resistors are shown in the auxiliary inverting amplifier stage 401B of FIG. 4A, other layouts are also contemplated, including using fewer or more RC components or placing them serially instead of in parallel, or vice versa.

FIG. 4B illustrates a loop gain measurement for a voltage regulating device 400B including a low dropout (LDO) voltage regulator 403A and an auxiliary inverting amplifier stage 403B according to aspects of the present disclosure. For illustrative purposes, some of the labelling and numbering of the components and features of FIG. 4B are similar to those of FIGS. 3 and 4A. The voltage regulating device 400B of FIG. 4B may be implemented in accordance with a feedback control loop such as the feedback control loop implemented in accordance with FIG. 3 and FIG. 4A to control the LDO voltage regulator. R₀ is an output impedance of the first error amplifier 302, the resistance, R_{OX} is an impedance of the second error amplifier 402, C_{X} is an equivalent capacitance at the output terminal 422, and Rf is a resistor ladder of the LDO voltage regulator. In one aspect, the resistor ladder of the LDO voltage regulator, Rf, is equal to a sum of the feedback resistors Rf1 and Rf2 of FIG. 4A. The parameter, b, is a feedback factor given by Rf2/(Rf1+Rf2).

Regulation characteristics of voltage regulators (e.g., low dropout (LDO) voltage regulator 401A or 403A) are defined by a converter loop transfer function. The transfer function may be a representation of a loop gain of the voltage feedback loop providing valuable information about stability of the power supply. The LDO voltage regulator 401A or 403A receives an input voltage Vin (or Vi) and generates a regulated output voltage Vout (or Vo) using the power transistor M_{pwr} (e.g., an NMOS transistor) as the power device. Accordingly, to measure the loop gain of the voltage feedback loop, the loop is broken at suitable points 428 and 430 and the input signal Vin is injected at point 428 while the output voltage Vout is measured at point 430. A total load resistance coupled to an output of the power transistor M_{pwr} may be given by a transistor based resistance (e.g., 1/(transconductance (gmp) of the transistor M_{pwr})) associated with the transistor M_{pwr}, a load resistance RL and other resistances (e.g., Rf) that are arranged in parallel.

An input to the to the first error amplifier 302 may be represented as follows:

$$vx = - \frac{{R}_{2}}{{R}_{1}} \cdot \frac{vi}{1 + {R}_{2} {C}_{f} \cdot s} \qquad ( 1 )$$

where vx is a voltage at node 310;

R1 and R2 are the first and second resistors of FIGS. 4A and 4B;

vi is equal to an input voltage (e.g., vin);

Cf is a capacitor that introduces an extra pole; and

s is a complex frequency.

The output voltage of the transistor M_{pwr} may be determined based on the EQUATION 1 and may be represented as follows:

$$( vx - vi ) \cdot Gm \cdot [ {R}_{o} // ( {R}_{z} + \frac{1}{{C}_{c} s} ) ] \cdot gmp \cdot ( {R}_{Load} // \frac{1}{{C}_{out} s} ) \cdot b = vo \qquad ( 2 )$$

where vo is an output voltage (e.g., vout);

Gm is a transconductance of the first error amplifier 302;

Ro is an equivalent output impedance of the first error amplifier 302;

C_{c} is a loop compensation capacitor;

R_{load} is a load resistance (e.g., RL) of the LDO voltage regulator;

R_{Z} is a nulling resistor (e.g., a resistor that creates a zero with C_{c} in the LDO feedback loop;

b is the feedback factor;

Cₒᵤₜ is a capacitor that may be implemented as an output filter; and

gmp is a transconductance of a p type transistor (e.g., power transistor M_{pwr}).

The loop gain (vo/vi) may be derived based on EQUATIONS 1 and 2 and may be represented by the following loop response equation:

$$\frac{vo}{vi} = - \frac{b \cdot ( 1 + \frac{{R}_{2}}{{R}_{1}} ) \cdot {G}_{m} \cdot {R}_{o} \cdot {g}_{m p} \cdot {R}_{load} \cdot ( 1 + {R}_{z} {C}_{c} \cdot s ) \cdot [ 1 + ( {R}_{1} // {R}_{2} ) {C}_{f} \cdot s ]}{( 1 + {R}_{o} {C}_{c} \cdot s ) \cdot ( 1 + {R}_{Load} {C}_{out} \cdot s ) ( 1 + {R}_{2} {C}_{f} \cdot s )} \qquad ( 3 )$$

Comparing a loop response according to aspects of the present disclosure to those of conventional LDO structures, a gain of the control loop according to aspects of the present disclosure is enhanced by a factor of 1+R2/R1.

Aspects of the present disclosure maintain a dominant pole, while improving the PSRR and load transient response as well as increasing bandwidth. Although the resistor R2 and the capacitor Cf introduce an extra pole, the resistor R2 and the capacitor Cf also introduce a zero that substantially cancels out the introduced pole.

FIG. 4C illustrates a small-signal equivalent circuit model 400C of a power amplifier/transistor of the voltage feedback loop including a low dropout (LDO) voltage regulator 405A and an auxiliary inverting amplifier stage 405B according to aspects of the present disclosure. For illustrative purposes, some of the labelling and numbering of the components and features of FIG. 4C are similar to those of FIGS. 3, 4A and 4B. To determine a small signal performance of a given transistor (e.g., MOSFET or bipolar junction transistor) amplifier circuit, the transistor may be replaced with a small signal model. The small-signal equivalent circuit model of a power amplifier/power transistor M_{pwr} may be represented as a hybrid-π model. A transistor with three terminals including a gate, a drain and a source, for example, may be described in terms of a current, i_{d}, and voltages v_{gs} and v_{ds}. A gain based on the small signal model may be derived based on EQUATIONS 4 and 5.

$$gm \cdot Ae \cdot ( - b \cdot vout \cdot {R}_{2} / {R}_{1} - b \cdot vout ) - vout ) \cdot ( ZL // Rf ) + \frac{vin - vout}{rds} \cdot ( ZL // Rf ) = vout \qquad ( 4 )$$

where gm is a transconductance of a transistor;

Ae is a gain of the LDO main amplifier (the first error amplifier 302 of FIG. 4C);

ZL is an equivalent impedance at the LDO terminal with output voltage Vout−ZL is contributed by the LDO output capacitor (Cout), the LDO load (RL) and an output impedance (1/gmp) of the LDO power FET; and

rds is a channel resistance of the LDO power field effect transistor.

$$\frac{vout ( s )}{vin ( s )} = \frac{1}{1 + \frac{rds}{ZL} + \frac{rds}{Rf} + \frac{( 1 + \frac{{R}_{2}}{{R}_{1}} ) \cdot b \cdot gm \cdot rds \cdot Aeo}{( 1 + \frac{s}{ω e} )}} \qquad ( 5 )$$

where Aeo is the gain of the LDO main amplifier, Ae, at DC (e.g., at angular frequency, ω=0); and

ωe is the LDO dominant pole angular frequency (e.g., ωe=1/(Ro*Cc) of FIG. 4B and Ae=Aeo/(1+s/ωe) such that when an angular frequency is beyond we, the gain Ae starts to drop).

Equation 4 is written based on the diagram shown in FIG. 4C to calculate power supply rejection ratio (PSRR) of the LDO (or in other words, the transfer function from vin to vout). EQUATION 5 is derived from EQUATION 4 and shows that vout(s)/vin(s) is much smaller than 1, which means the noise presented at the LDO input (vin) is suppressed by the LDO loop when present at the LDO output (vout). Comparing the current structure to conventional structures, the term 1+R2/R1 is introduced by the inverting amplifier stage 403B (of FIG. 4B) to cause the proposed structure to achieve better power supply rejection ratio (PSRR). Thus, the PSRR of the LDO structure of the present disclosure is an improvement compared to conventional LDO structures, due to the enhanced loop gain.

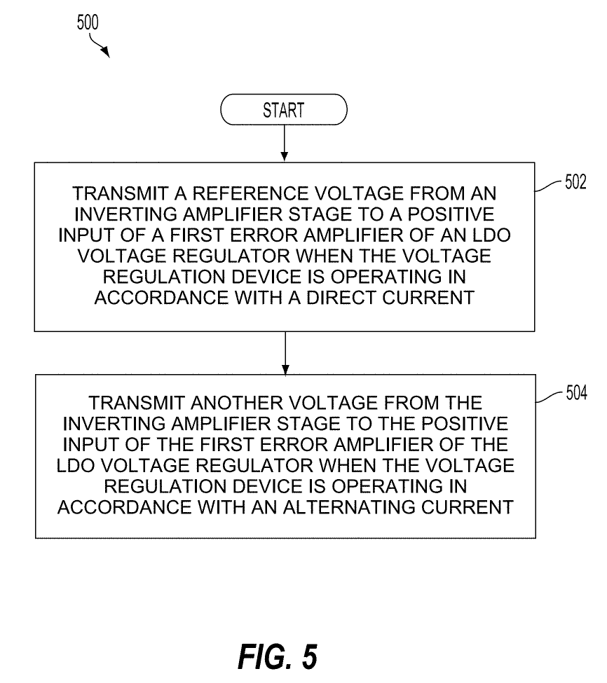

FIG. 5 is a process flow diagram illustrating a voltage regulation method 500 according to an aspect of the present disclosure. In block 502, an inverting amplifier stage of a voltage regulation device transmits a reference voltage to a positive input of a first error amplifier of an LDO voltage regulator (low dropout voltage regulator) when the voltage regulation device is operating in accordance with a direct current (DC). In block 504, the inverting amplifier stage transmits another voltage to the positive input of the first error amplifier of the LDO voltage regulator when the voltage regulation device is operating in accordance with an alternating current (AC).

In one aspect, an output fed back from the low dropout (LDO) voltage regulator is received at a negative input of the inverting amplifier stage. The other voltage may be a function of the output fed back from the LDO voltage regulator and one or more resistors coupled to a negative input of the inverting amplifier stage. The reference voltage may be received at a positive input of the inverting amplifier stage. The other voltage may be based on a differential alternating current signals.

According to a further aspect of the present disclosure, a voltage regulation device is described. The voltage regulation device includes means for amplifying a voltage. The voltage amplifying means may be the auxiliary inverting amplifier stage 401B, the second error amplifier 402, the second buffer driver 404, the capacitor Cf, and/or the first and second resistors R1 and R2. The voltage regulation device also includes means for amplifying an error signal. The error signal amplifying means may be the first error amplifier 302, the second error amplifier 402, the first buffer driver 304 and/or the second buffer driver 404. The voltage regulation device also includes means for stabilizing a control feedback loop. The control feedback loop stabilizing means may be the capacitor Cf, the capacitor Cc, the resistor Rz and/or the first and second resistors R1 and R2. The voltage regulation device includes means for buffering. The buffering means may be first buffer driver 304 and/or the second buffer driver 404. In another aspect, the aforementioned means may be any module or any apparatus configured to perform the functions recited by the aforementioned means.

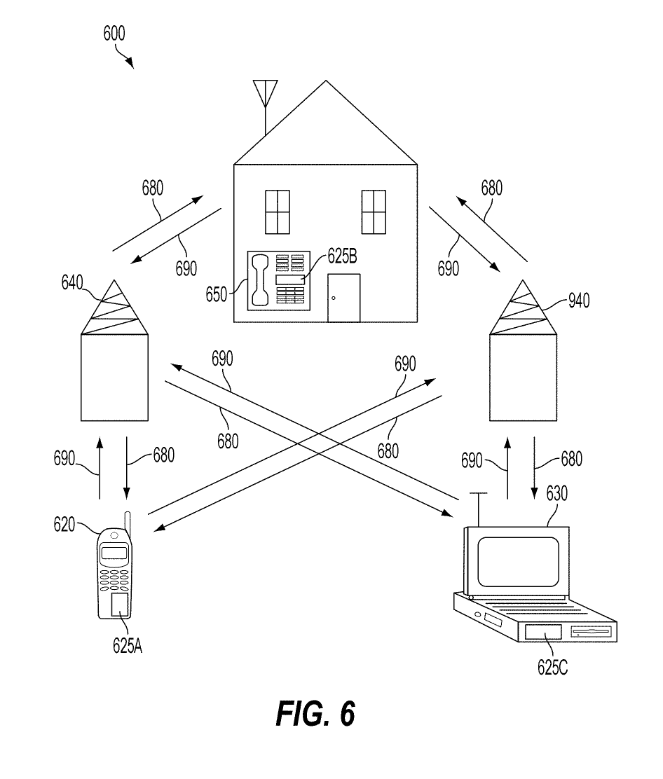

FIG. 6 is a block diagram showing an exemplary wireless communication system 600 in which an aspect of the present disclosure may be advantageously employed. For purposes of illustration, FIG. 6 shows three remote units 620, 630, and 650 and two base stations 640. It will be recognized that wireless communication systems may have many more remote units and base stations. Remote units 620, 630, and 650 include IC devices 625A, 625C, and 625B that include the disclosed voltage regulation device. It will be recognized that other devices may also include the disclosed voltage regulation device, such as the base stations, switching devices, and network equipment. FIG. 6 shows forward link signals 680 from the base station 640 to the remote units 620, 630, and 650 and reverse link signals 690 from the remote units 620, 630, and 650 to base station 640.

In FIG. 6, remote unit 620 is shown as a mobile telephone, remote unit 630 is shown as a portable computer, and remote unit 650 is shown as a fixed location remote unit in a wireless local loop system. For example, a remote units may be a mobile phone, a hand-held personal communication systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed voltage regulation device.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

1. A voltage regulation circuit, comprising:
an LDO voltage regulator (low dropout voltage regulator) comprising a first error amplifier and a power field effect transistor (FET), the first error amplifier having a first input and a second input, the second input to receive an output signal fed back from the LDO voltage regulator; and
an inverting amplifier stage having an output terminal coupled to the first input of the first error amplifier, the inverting amplifier stage having a first input that receives the output fed back from the LDO voltage regulator and a second input that receives a reference voltage.

2. The voltage regulation circuit of claim 1, in which the inverting amplifier stage comprises a second error amplifier, a first resistor in series with the second error amplifier and a second resistor in parallel with the second error amplifier.

3. The voltage regulation circuit of claim 2, in which the inverting amplifier stage further comprises a capacitor in parallel with the second resistor.

4. The voltage regulation circuit of claim 2, in which the inverting amplifier stage further comprises a buffer coupled between an output of the second error amplifier and the first input of the first error amplifier.

5. The voltage regulation circuit of claim 1, in which the inverting amplifier stage comprises a cascade operational transconductance amplifier, non-cascade amplifier, or a driver amplifier.

6. The voltage regulation circuit of claim 1, in which the output signal received by the first error amplifier includes differential alternating current based signals.

7. A voltage regulation circuit, comprising:
an LDO voltage regulator (low dropout voltage regulator) comprising a first error amplifier and a power field effect transistor (FET), the first error amplifier having a first input and a second input, the second input to receive an output signal fed back from the LDO voltage regulator; and
means for amplifying a voltage, the voltage amplifying means coupled to the first input of the first error amplifier, the voltage amplifying means including means for receiving the output signal fed back from the LDO voltage regulator and means for receiving a reference voltage.

8. The voltage regulation circuit of claim 7, in which the voltage amplifying means comprises means for amplifying an error signal, and means for stabilizing a control feedback loop including the voltage amplifying means and the LDO voltage regulator.

9. The voltage regulation circuit of claim 8, further comprising a capacitor coupled to the control feedback loop stabilizing means to further stabilize the control feedback loop.

10. The voltage regulation circuit of claim 8, in which the voltage amplifying means further comprises means for buffering an output of the error signal amplifying means, the error signal amplifying means coupled to the first input of the first error amplifier.

11. The voltage regulation circuit of claim 10, in which the output signal received by the first error amplifier includes differential alternating current based signals.

12. A voltage regulation method in a voltage regulation device, comprising:
transmitting a reference voltage from an inverting amplifier stage to a first input of a first error amplifier of an LDO voltage regulator (low dropout voltage regulator) when the voltage regulation device is operating in accordance with a direct current; and
transmitting a different voltage from the inverting amplifier stage to the first input of the first error amplifier of the LDO voltage regulator when the voltage regulation device is operating in accordance with an alternating current.

13. The voltage regulation method of claim 12, further comprising receiving an output fed back from the LDO voltage regulator at a first input of the inverting amplifier stage.

14. The voltage regulation method of claim 13, in which receiving the output fed back from the LDO voltage regulator comprises receiving the output fed back from the LDO voltage regulator at a first input of a second error amplifier of the inverting amplifier stage.

15. The voltage regulation method of claim 14, further comprising receiving the reference voltage at a second input of the inverting amplifier stage.

16. The voltage regulation method of claim 14, in which receiving the reference voltage further comprises receiving the reference voltage at a second input of the second error amplifier.

17. The voltage regulation method of claim 12, further comprising buffering the reference voltage or the different voltage prior to reception at the first error amplifier.

18. The voltage regulation method of claim 12, in which the different voltage comprises differential alternating current based signals.
